(19) United States
(12) Patent Application Publication
(10) Pub. No.: US 2008/0144579 A1
(43) Pub. Date: Jun. 19, 2008

(54) FAST TRANSITIONING ADVERTISEMENT

(76) Inventor: Kapil Sood, Beaverton, OR (US)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/613,094

(22) Filed: Dec. 19, 2006

(51) Int. Cl. H04Q 7/00

(52) U.S. Cl. 370/332

(57) ABSTRACT

Embodiments of apparatuses, articles, methods, and systems for utilizing a fast transitioning advertisement in wireless networks are generally described herein. Other embodiments may be described and claimed.

### FIELD

Embodiments of the present invention relate generally to the field of wireless networks, and more particularly to fast transitioning advertisements in said wireless networks.

### BACKGROUND

A communication session in a wireless network typically involves a local station communicating with a remote station via a communication link. The communication link may include a wireless connection between the local station and an access point. For various reasons, the quality of the wireless connection between the access point and the local station may deteriorate. This may be due to overloading of the access point, mobility of the station, interference, etc. In order to preserve the established communication link, the local station may reassociate the wireless connection with another access point. When the communication session involves delay intolerant transmissions, e.g., voice or video, various quality of resource (QoS) challenges are presented for a successful and efficient reassociation of the wireless connection.

### BRIEF DESCRIPTION OF THE DRAWINGS

Embodiments of the invention are illustrated by way of example and not by way of limitation in the figures of the accompanying drawings, in which like references indicate similar elements and in which:

FIG. 1 illustrates a network providing for fast transitioning in accordance with various embodiments of this invention;

FIG. 2 illustrates a mobility domain information element in accordance with various embodiments of this invention;

FIG. 3 illustrates an association policy in accordance with various embodiments of this invention;

FIG. 4 illustrates a fast transitioning information element in accordance with various embodiments of this invention;

FIG. 5 illustrates a flowchart depicting a fast transitioning operation in accordance with various embodiments of this invention;

FIG. 6 illustrates message sequences of a fast transitioning operation in accordance with various embodiments of this invention;

FIG. 7 illustrates components of a station in accordance with various embodiments of this invention;

FIG. 8 illustrates components of an access point in accordance with various embodiments of this invention; and

FIG. 9 illustrates a computing device in accordance with various embodiments of this invention.

### DETAILED DESCRIPTION

Embodiments of the present invention may provide a method, article of manufacture, apparatus, and system for fast transitioning advertisements in wireless networks.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific devices and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the present invention; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise.

In providing some clarifying context to language that may be used in connection with various embodiments, the phrase “A/B” means (A) or (B); the phrase “A and/or B” means (A), (B), or (A and B); and the phrase “A, B, and/or C” means (A), (B), (C), (A and B), (A and C), (B and C) or (A, B and C).

As used herein, reference to a “component” may refer to a hardware, a software, and/or a firmware component employed to obtain a desired outcome. Although only a given number of discrete components may be illustrated and/or described, such components may nonetheless be represented by additional components or fewer components without departing from the spirit and scope of embodiments of the invention.

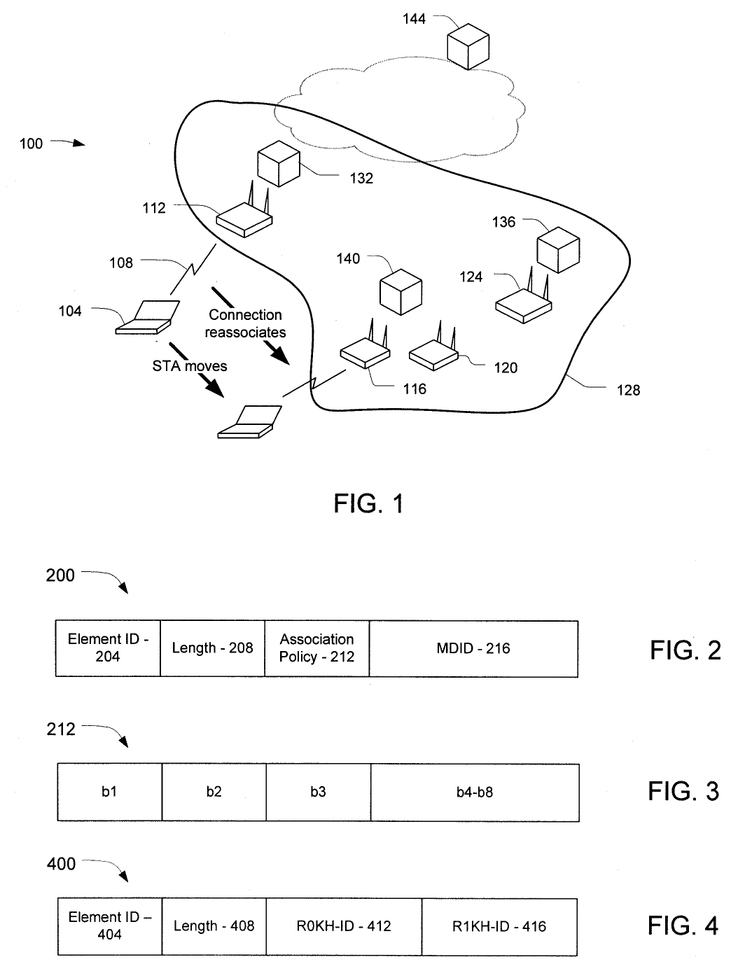

FIG. 1 illustrates a network 100 supporting fast transitioning (FT) of mobile wireless devices utilizing FT advertisements in accordance with an embodiment of this invention. “Fast transitioning” may also be referred to as “fast roaming.”

Briefly, the network 100 may include a wireless network node, e.g., station 104, having a wireless connection 108 with another wireless network node, e.g., access point (AP) 112. The network 100 may also include other wireless network nodes, e.g., APs 116, 120, and 124. The APs may be part of a mobility domain (MD) 128 operated by an infrastructure provider. The provider may define the MD 128 as an administrative function.

The wireless connection 108 may be initially associated with the AP 112 at the beginning of a communication session. If the station 104 observes deterioration in the quality of the wireless connection 108, the station 104 may initiate FT operations in order to reassociate the wireless connection 108 with another AP that is capable of providing appropriate quality of service (QoS) levels given the nature of the communication session. In various embodiments, the communication session may include delay and/or jitter sensitive network traffic such as, but not limited to, streaming multimedia, Internet protocol (IP) telephony (e.g., voice-over IP (VoIP)), video teleconferencing, etc. Accordingly, it may be desirable for an FT operation to occur in a manner such that a detectable disruption to the established communication session may be avoided.

Prior to reassociating the wireless connection 108, the station 104 may look to discover the policy and capabilities of other neighboring APs to determine if an FT operation is possible. If an FT operation is possible with one or more of the APs, the station 104 may identify those APs as reassociation targets and reassociate with a selected one of the reassociation targets when desired.

The APs of the MD 128 may transmit management frames, e.g., beacons and/or probe responses, to provide stations with the information to determine acceptable reassociation targets. Beacons may be periodically broadcast (e.g., once every 100 milliseconds) by the APs. Probe responses may be replies from an AP to a station's probe request.

Large size beacons and probes may introduce latency and processing delays at all wireless devices, thereby making the operation of the network 100 more power consuming and slow. Undesired elements in a beacon may result in undue processing overhead within and between components of the wireless devices. Accordingly, embodiments of this invention may facilitate FT operations by reducing broadcast overhead. Small broadcast messages may increase packet transmission efficiency over the air (OTA) and may be faster to process and act upon.

In an embodiment of this invention, the AP 116 may broadcast a low-overhead beacon. In an embodiment, the broadcast beacon may simply include a mobility domain information element (MDIE), which comprises a unique mobility domain identifier (MDID) and an association policy.

In an embodiment, the station 104 may reassociate the wireless connection 108 with any AP that is operating within the same mobility domain (MD) in which the AP 112 operates, e.g., MD 128. Accordingly, the MDID may be included in the MDIE so that the station 104 may determine whether the AP 116 resides in the MD 128. If the MDID of the broadcast beacon matches the MDID of the AP 112, the station 104 may identify the AP 116 as a reassociation target.

Prior to reassociating the wireless connection 108 with the AP 116, the station 104 and the AP 116 may exchange security information. This exchange of security information may be done according to the association policy communicated in the MDIE. Security information may be exchanged through a series of unicast association management messages.

The communication session may be secured through a number of key holders distributed throughout the MD 128. Each AP may be associated with a key holder (KH). For example, AP 112 may be associated with KH 132; both APs 116 and 120 may be associated with KH 140; and AP 124 may be associated with KH 136. As can be seen, a KH may be uniquely associated with an AP (and may sometimes be implemented in the same device) or a KH may be associated with more than one AP.

Upon initial association of the wireless connection 108, the station 104 and an authentication server 144 may mutually authenticate each other using, e.g., an extensible authentication protocol (EAP). Upon mutual authentication, the authentication server 144 may deliver a master secret key (MSK) to the AP 112 and the station 104.

The KH associated with the AP 112, e.g., KH 132, may use the MSK to compute a pairwise master key (PMK)-R0. In this context, the KH 132 may also be referred to as the R0KH 132. The R0KH 132 may use the PMK-R0 and an identity of an R1KH, which may be the R0KH 132 for the initial association, to generate a PMK-R1 key. The PMK-R1 key may then be used in deriving a pairwise transient key (PTK) session key.

The station 104 may use the MSK to derive the PMK-R0, PMK-R1, and PTK keys in a similar manner as the R0KH 132. The keys derived by the station 104 may match those derived by the R0KH 132 as both use the same ingredients in the same key derivation function.

When the station 104 targets AP 116 for reassociation, the KH associated with the AP 116, e.g., KH 140, and the station 104 may need to derive a new PTK. To do so, the KH 140 may need the identity of the R0KH 132, which may be responsible for generating and delivering the PMK-R1 keys to the KHs of the MD 128, in order to request the PMK-R1 key. Upon receiving a PMK-R1 key from the R0KH 132, the KH 140, which may be referred to as R1KH 140 in this instance, may derive a PTK.

The station 104 may receive the identity of the R1KH 140 and derive a PTK session key that should match the PTK session key generated by the R1KH 140.

Accordingly, in some embodiments security information exchanged in the series of unicast association messages prior to reassociation may include identities of various key holders, e.g., R0KH-ID and R1KH-ID, to facilitate the derivation and distribution of the PMK-R1 keys. These KH-IDs may be communicated through fast transition information elements (FTIE).

In various embodiments, an identity of a wireless network node may be a network address such as, but not limited to, a media access control (MAC) address.

In various embodiments, the network 100 may be a wireless local area network (WLAN), a wireless metropolitan access network (WMAN), etc. In an embodiment, the wireless network 100 may comply with one or more of the Institute of Electrical and Electronics Engineers (IEEE) wireless standards, e.g., the 802.11-2003 and/or 802.16-2004 standards along with any revisions, amendments or updates thereto.

While the above embodiment discusses an initial association of a wireless connection between a station and an access point and a reassociation of the wireless connection to another access point, other embodiments may include associations among other combinations of wireless network nodes. For example, the association of a wireless connection may be between an AP and another AP, a station and another station, etc. As used herein an “association” may include both an initial association and a reassociation.

Wireless network nodes may be any type of device capable of performing associations involved in the FT operations described herein. In some embodiments network nodes may be mobile network client devices such as, but not limited to, a personal computing device, a laptop computing device, a phone, etc., or network infrastructure devices, e.g., a server, an access point, etc.

FIGS. 2-4 illustrate some of the aforementioned information elements and sub-elements thereof in accordance with various embodiments of this invention. FIG. 2, in particular, illustrates an MDIE 200 that may be broadcast by the AP 116 in accordance with an embodiment of this invention. The MDIE 200 may have an element ID 204, a length 208, an association policy 212, and an MDID 216. In an embodiment, the first three parts of the MDIE 200 (e.g., element ID 204, the length 208, and the association policy 212) may each be one octet; while the MDID 216 may be six octets. In this embodiment, the length 208 may be seven, indicating the size of the remaining parts, e.g., the association policy 212 and the MDID 216. Accordingly, the total size of the MDIE 200 may be only nine octets.

The information advertised by the AP 116 by broadcasting the MDIE 200 may be sufficient for the station 104 to determine whether the AP 116 may be targeted for reassociation. The other APs, e.g., APs 116, 120, and 124, may broadcast similar MDIEs; however, the association policy communicated in the MDIE may be different for each AP. The MDIEs may be advertised by the APs in their beacons and probe responses.

As used herein, an association policy may provide information on a procedure for a station to use when it is associating or reassociating a wireless connection with an AP. FIG. 3 illustrates the association policy 212 in accordance with various embodiments of this invention. The association policy 212 may include a first bit b1 to indicate an AP's QoS reservation policy. As used herein, a policy allowing pre-reservation of QoS may be referred to as a “pre-reservation policy” while a policy that does not may be referred to as a “base policy.” In an embodiment, if the bit b1 is set to zero, a station reassociating a wireless connection may adhere to the base policy and if the bit b1 is set to one, the station may use either the base or the pre-reservation policy.

The second bit b2 and the third bit b3 may provide information on an AP's management message transmission scheme in accordance with various embodiments of this invention. For example, a second bit b2 of the association policy 212 may indicate whether the association management messages may be transmitted OTA. A third bit b3 of the reassociation policy 212 may indicate whether reassociation management messages may be transmitted over the distribution system (ODS), e.g., via the AP 112.

Bits b4-b8 may be reserved in this embodiment. In other embodiments, one of the reserved bits, e.g., bit b4, may be used to indicate whether the KH 140 associated with the AP 116 is also associated with another AP. In some embodiments selecting a target AP that shares a KH with the current AP may facilitate FT operations by, e.g., reducing key computations.

FIG. 4 illustrates an FTIE 400 that may be exchanged in unicast association management messages in accordance with various embodiments of the present invention. The FTIE 400 may include an element ID 404, a length 408, and an R0KH-ID 412. In some embodiments, depending on the stage of the exchange, the FTIE 400 may also include an R1KH-ID. In an embodiment, the first two parts of the FTIE 400 (e.g., element ID 404 and the length 408) may each be one octet; while the KH-IDs, e.g., the R0KH-ID 412 and R1KH-ID 416, may be forty-eight octets and six octets, respectively. In this embodiment, the length 408 may be forty-eight if only the R0KH-ID is included, or fifty-four if both the R0KH-ID and the R1KH-IDs are included. Accordingly, the total size of the FTIE 400 may be fifty or fifty-six octets in accordance with this embodiment.

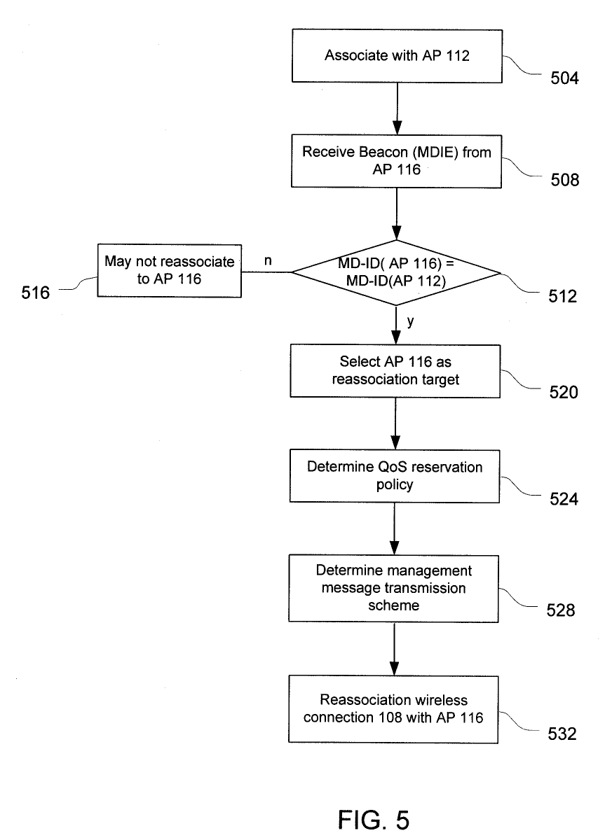

FIG. 5 illustrates a flowchart depicting an FT operation in accordance with various embodiments of this invention. In this embodiment, the station 104 may initially associate the wireless connection 108 with AP 112 at block 504. Sometime after the initial association, the station 104 may decide to begin an FT operation. As discussed above, this may be due to a deterioration in the wireless connection 108; however, other scenarios may also motivate an FT operation. The station 104 may receive a beacon including an MDIE from the AP 116 at block 508. The station 104 may determine whether the MDID in the beacon matches the MDID of the current AP, e.g., AP 112, at block 512. If the MDIDs are not the same, the station 104 may determine that it may not reassociate the wireless connection 108 with AP 116 at block 516. If the MDIDs are the same, the station 104 may select AP 116 as a reassociation target at block 520.

After selecting the AP 116 as a reassociation target at block 520, the station 104 may determine the QoS reservation policy of the AP 116 communicated in the association policy of the MDIE at block 524. If the MDIE indicates that either the base or pre-reservation policy may be used for reassociation, the station 104 may have the liberty to choose which policy to use for reassociation.

The station 104 may consider a number of factors in choosing between the two policies. For example, the pre-reservation policy may introduce latency into the infrastructure to provide the AP 116 additional time to process QoS calculations by having them done prior to the reassociation request. The base policy, on the other hand, may conserve the resources of the station 104 by providing reduced transmissions and saving power compared to the pre-reservation policy. Additionally, if the station 104 senses wireless congestion, it may wish to pre-reserve QoS resources at a plurality of APs, and reassociate with a selected one of the plurality of APs when desired.

The station 104 may also reference the MDIE to determine a management message transmission scheme at block 528. The transmission scheme may be OTA, ODS, or either.

The station 104 may reassociate the wireless connection 108 with the AP 116 according to the determined policy and transmission scheme at block 532.

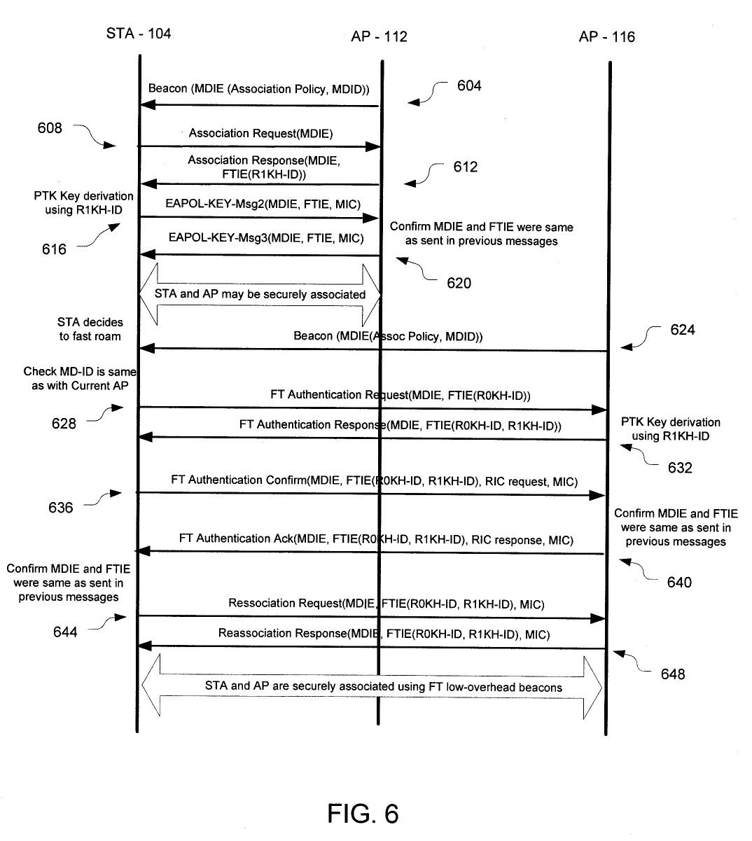

FIG. 6 illustrates message sequences of an FT (re)association procedure in accordance with various embodiments of the present invention. In this embodiment, the AP 112 may broadcast its beacon 604. The beacon 604 may include an MDIE, which may be structurally similar to MDIE 200, having an association policy of the AP 112 and an MDID for the MD 128.

The station 104 may decide to perform an initial association with the AP 112 and transmit an association request 608 that includes the received MDIE. The AP 112 may respond with an association response 612 that includes the MDIE and an FTIE, which may be structurally similar to FTIE 400, having R1KH-ID (in this case, the ID of the KH 132), which tells the station 104 on what PMK-R1 to derive.

The station 104 and the authentication node 144 may conduct an EAP authentication as described above. Following the EAP authentication, EAPOL Key messages used for key management for deriving PTK keys may be exchanged. This exchange may include the station 104 transmitting EAPOL-Key Msg 2 616, which includes the previously transmitted MDIE and FTIE along with a message integrity check (MIC), and the AP 112 transmitting EAPOL-Key Msg 3 620, which may also include the MDIE and FTIE along with the MIC.

Transmitting the MDIE and FTIE with the MIC may provide some level of assurance to the station 104 and AP 112 that the information elements that the association is based upon, transmitted in previous messages, are genuine and not generated from an impostor. Upon this successful negotiation, the station 104 and the AP 112 may be securely associated.

The station 104 may decide to fast roam sometime after the initial association. The station 104 may receive a beacon 624, broadcast by the AP 116, including an MDIE with the association policy of AP 116 and the MDID of MD 128. The station 104 may confirm that the MDID of the AP 116 is the same as the MDID of the AP 112, originally received in the beacon 604, and identify the AP 116 as a reassociation target. Other embodiments may include pre-reservation policy with an OTD transmission scheme, or a base policy with an OTA or OTD transmission scheme.

After the station 104 identifies the AP 116 as the reassociation target it may proceed to exchange KH-IDs according to the association policy communicated in the MDIE. In this embodiment, the association policy may be a pre-reservation policy negotiated with an OTA transmission scheme.

The station 104 may begin the KH-ID exchange by transmitting an FT authentication request 628 repeating the MDIE of the beacon 624 and including an FTIE providing the R0KH-ID. The AP 116 may respond to the FT authentication request 628 with an FT authentication response 632 repeating the MDIE and including an FTIE having the R0KH-ID and an R1KH-ID. The AP 116 may use the R0KH-ID to obtain a PMK-R1 from the R0KH 140; while the station 104 may use the R1KH-ID to derive the PMK-R1. This PMK-R1 may then be used to derive the PTK key for securing communications between the AP 116 and the station 104 throughout the communication session.

With the appropriate keys derived, the station 104 may transmit an FT authentication confirmation 636 repeating the MDIE and FTIE of the FT authentication response 632 along with a MIC to provide assurance to the AP 116 of the integrity and source authentication of the information elements. In an embodiment, the FT authentication confirmation 636 may also include a resource information container (RIC) request having a resource descriptor information element (RDIE) that includes a requested QoS resource.

The AP 116 may confirm that the MDIE and the FTIE were the same as sent in previous messages, e.g., in the FT authentication response 632, and may also determine whether it has the requested QoS resource available for allocation to the station 104. The AP 116 may then prepare and transmit an FT authentication acknowledgement 640 repeating the MDIE and the FTIE along with a MIC to provide assurance to the station 104 of the integrity and source authentication of the information elements. In an embodiment, the FT authentication acknowledgement 640 may also include a RIC response indicating whether the requested QoS resource was allocated to the station 104.

If everything is deemed acceptable, the station 104 may execute the reassociation by transmitting a reassociation request 644, having an MDIE, an FTIE, and a MIC, and the AP 116 may respond by generating and transmitting a reassociation response 648 echoing the elements of the reassociation request 644 with another MIC. At this point, the reassociation of the wireless connection 108 to the AP 116 may be complete.

As stated above, the procedures shown and discussed in FIG. 6 are directed towards a pre-allocation policy. In a base policy embodiment, the FT authentication confirmation 636 and/or FT authentication acknowledgement 640 messages, and the functions that they include (e.g., resource allocation and integrity checks) may occur at or after the reassociation management messages, e.g., the reassociation request 644 and/or the reassociation response 648.

As also stated above, the procedures shown and discussed in FIG. 6 may be directed towards an OTA transmission scheme. In an ODS embodiment, the management authentication messages, e.g., FT authentication request 628, the FT authentication response 632, the FT authentication confirmation 636, and the FT authentication acknowledgement 640, may be referred to as management action messages, e.g., an FT action request, an FT action response, an FT action confirmation, and an FT action acknowledgement. However, the elements contained in these messages may be similar. As used herein an FT request may refer to either an FT authentication request or an FT action request; an FT response may refer to an FT authentication response or an FT action response; and so forth.

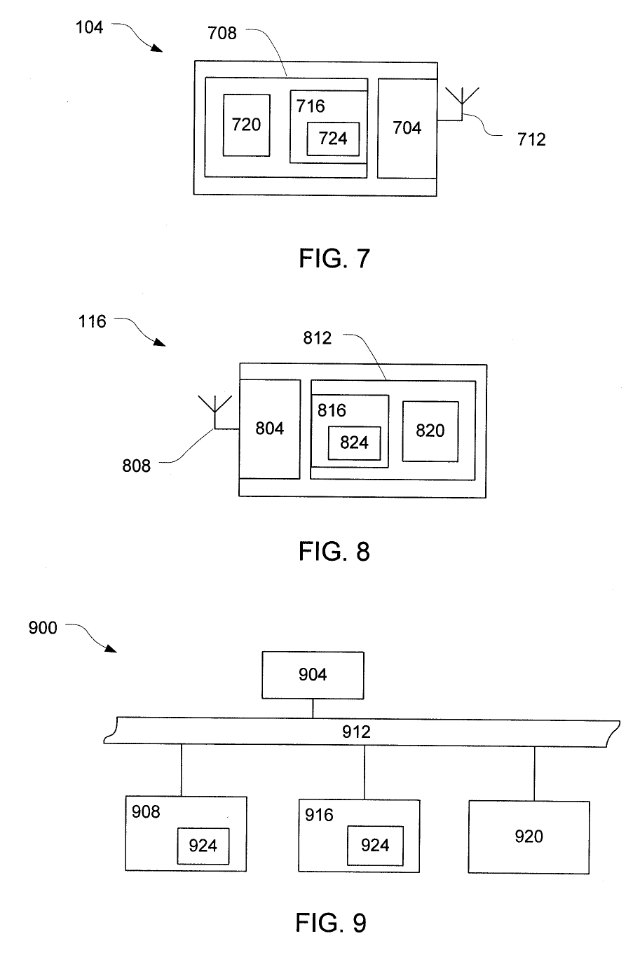

FIG. 7 illustrates components of the station 104 in accordance with various embodiments of this invention. The station 104 may include a wireless network interface card (WNIC) 704 to facilitate wireless communication with other devices of the network 100. The WNIC 704 may facilitate processing of messages to and/or from components of a host 708. The WNIC 704 may cooperate with an antenna structure 712 to provide access to other devices of the network 100.

In various embodiments, the antenna structure 712 may include one or more directional antennas, which radiate or receive primarily in one direction (e.g., for 120 degrees), cooperatively coupled to one another to provide substantially omnidirectional coverage; or one or more omnidirectional antennas, which radiate or receive equally well in all directions.

In various embodiments, the host 708 may include a driver, e.g., wireless local area network (WLAN) driver 716, to drive the WNIC 704 for other components of the host 708 such as a transitioning manager 720. The transitioning manager 720 may control FT operations of the station 104 such as those discussed in embodiments of this invention.

In an embodiment the driver 716 may include a supplicant 724 to act as a security software component, e.g., for performing MIC calculations.

FIG. 8 illustrates components of the AP 116 in accordance with various embodiments of this invention. The AP 116 may include a WNIC 804 and antenna structure 808 to facilitate wireless communication with wireless devices of the network 100, similar to like-name components of the station 104. The AP 116 may include a host 812 having a driver 816 to drive the WNIC 804 for other components of the host 812 such as an association manager 820. The association manager 160 may control FT operations of the AP 116 such as those discussed in embodiments of this invention.

In an embodiment the driver 816 may include a supplicant 824 to act as a security software component, e.g., for performing MIC calculations.

FIG. 9 illustrates a computing device 900 capable of implementing an wireless network device in accordance with various embodiments. As illustrated, for the embodiments, computing device 900 includes processor 904, memory 908, and bus 912, coupled to each other as shown. Additionally, computing device 900 includes storage 916, and communication interfaces 920, e.g., a WNIC, coupled to each other, and the earlier described elements as shown.

Memory 908 and storage 916 may include in particular, temporal and persistent copies of FT logic 924, respectively. The FT logic 924 may include instructions that when accessed by the processor 904 result in the computing device 900 performing FT operations described in conjunction with various wireless network devices in accordance with embodiments of this invention.

In various embodiments, the memory 908 may include RAM, dynamic RAM (DRAM), static RAM (SRAM), synchronous DRAM (SDRAM), dual-data rate RAM (DDRRAM), etc.

In various embodiments, the processor 904 may include one or more single-core processors, multiple-core processors, controllers, application-specific integrated circuits (ASICs), etc.

In various embodiments, storage 916 may include integrated and/or peripheral storage devices, such as, but not limited to, disks and associated drives (e.g., magnetic, optical), universal serial bus (USB) storage devices and associated ports, flash memory, read-only memory (ROM), non-volatile semiconductor devices, etc.

In various embodiments, storage 916 may be a storage resource physically part of the computing device 900 or it may be accessible by, but not necessarily a part of, the computing device 900. For example, the storage 916 may be accessed by the computing device 900 over a network.

In various embodiments, computing device 900 may have more or less components, and/or different architectures. In various embodiments, computing device 900 may be a station, an access point, or some other wireless network node.

Although the present invention has been described in terms of the above-illustrated embodiments, it will be appreciated by those of ordinary skill in the art that a wide variety of alternate and/or equivalent implementations calculated to achieve the same purposes may be substituted for the specific embodiments shown and described without departing from the scope of the present invention. Those with skill in the art will readily appreciate that the present invention may be implemented in a very wide variety of embodiments. This description is intended to be regarded as illustrative instead of restrictive on embodiments of the present invention.

What is claimed is:

1. A method comprising:
receiving, by a network node, a beacon broadcast from another network node, the beacon including a mobility domain information element (MDIE) having an association policy and a mobility domain identifier (MDID);
selecting, by the network node, the another network node as an association target based at least in part on the MDIE; and
exchanging, by the network node, a plurality of key holder identities with the another network node.

2. The method of claim 1, further comprising:
establishing, by the network node, a wireless connection with yet another network node, and the association target is a target for reassociating the wireless connection from the yet another network node to the another network node.

3. The method of claim 2, wherein said exchanging of a plurality of key holder identities with the another network node comprises:
transmitting, by the network node, a fast transition (FT) request to the another network node, the FT request including an FT information element (FTIE) having an identification of a key holder associated with the yet another network node; and
receiving, by the network node, an FT response from the another network node, the FT response including another FTIE having an identification of another key holder associated with the another network node.

4. The method of claim 3, wherein the another FTIE further includes the identification of the key holder associated with the yet another network node and the method further comprises:
transmitting, by the network node, an FT confirmation to the another network node, the FT confirmation including the another FTIE and a message integrity check (MIC); and
receiving, by the network node, an FT acknowledgement from the another network node, the FT acknowledgement including the another FTIE and another MIC.

5. The method of claim 4, wherein the association policy indicates whether the another network node allows reservation of quality of service (QoS) resources prior to reassociating the wireless connection.

6. The method of claim 5, wherein the association policy indicates that the another network node does allow reservation of QoS resources prior to reassociating the wireless connection and the method further comprises:
transmitting, by the network node, a reassociation request to the another network node subsequent to said receiving of an FT acknowledgement.

7. The method of claim 6, wherein the FT confirmation further includes a QoS resource request.

8. The method of claim 4, wherein each of the FT request, the FT response, the FT confirmation, and the FT acknowledgement further include the MDIE.

9. The method of claim 3, wherein the FT request and the FT response are unicast messages.

10. The method of claim 1, further comprising:
determining, by the network node referencing the association policy, that the another network node allows at least over-the-air (OTA) or over-the-distribution system (ODS) transmission of association management messages including one or more messages involved in said exchanging of a plurality of key holder identities; and
selecting the another network node based at least in part on said determining.

11. A system comprising:
an omnidirectional antenna coupled to a host and configured to provide access to a wireless network; and
the host including a transitioning manager configured
to receive, via the omnidirectional antenna, a beacon broadcast from a network node, the beacon including a mobility domain information element (MDIE) having an association policy and a mobility domain identifier (MDID);
to select the network node as an association target based at least in part on the MDIE; and
to exchange, via the omnidirectional antenna, a plurality of key holder identities with the network node.

12. The system of claim 11, wherein the transitioning manager is further configured to establish a wireless connection, via the omnidirectional antenna, with another network node, and the association target is a target for reassociating the wireless connection from the another network node to the network node.

13. The system of claim 12, wherein the transitioning manager is configured to exchange the plurality of key holder identities by being configured
to transmit, via the omnidirectional antenna, a fast transition (FT) request to the network node, the FT request including an FT information element (FTIE) having an identification of a key holder associated with the another network node; and
to receive, via the omnidirectional antenna, an FT response from the network node, the FT response including another FTIE having an identification of another key holder associated with the network node.

14. The system of claim 13, wherein the transitioning manager is configured to exchange the plurality of key holder identities by being configured
to transmit, via the omnidirectional antenna, an FT confirmation to the network node, the FT confirmation including the another FTIE and a message integrity check (MIC); and
to receive, via the omnidirectional antenna, an FT acknowledgement from the network node, the FT acknowledgement including the another FTIE and another MIC.

15. The system of claim 11, wherein said MDIE is nine octets.

16. An apparatus comprising:
a wireless network interface card coupled to a host and configured to provide the host access to a wireless network; and
the host including an association manager configured
to broadcast, via the wireless network interface, a beacon including a mobility domain information element (MDIE) having an association policy and a mobility domain identifier (MDID); and
to exchange, via the wireless network interface, a plurality of key holder identities with a network node seeking to associate a wireless connection with the apparatus.

17. The apparatus of claim 16, wherein the wireless connection is an existing wireless connection between the network node and another network node and the network node is seeking to reassociate the existing wireless connection from the another network node to the apparatus.

18. The apparatus of claim 17, wherein the association manager is configured to exchange the plurality of key holder identities by being configured to receive, via the wireless network interface, a fast transitioning (FT) request from the network node, the FT request including the MDIE and an FT information element (FTIE) having an identification of a key holder associated with the another network node.

19. The apparatus of claim 18, wherein the association manager is further configured to transmit, via the wireless network interface, in response to the FT request, an FT response to the network node, the FT response including another FTIE having the identification of the key holder and an identification of another key holder associated with the apparatus.

20. The apparatus of claim 19, wherein the association manager is configured to exchange the plurality of key holder identities by being further configured
to receive, via the wireless network interface, an FT confirmation from the network node, the FT confirmation including the another FTIE and a message integrity check (MIC); and
to transmit, via the wireless network interface, an FT acknowledgement to the network node, the FT acknowledgement including the another FTIE and another MIC.

21. The apparatus of claim 20, wherein the association manager is further configured to facilitate reassociation of the wireless connection from the another network node to the apparatus.

22. The apparatus of claim 16, wherein the MDIE is nine octets.

23. A machine-accessible medium having associated instructions, which, when executed results in a network node
receiving a beacon broadcast from another network node, the beacon including a mobility domain information element (MDIE) having an association policy and a mobility domain identifier (MDID);
selecting the another network node as an association target based at least in part on the MDIE; and
exchanging a plurality of key holder identities with the another network node.

24. The machine-accessible medium of claim 23 having associated instructions, which, when executed, further results in the network node
establishing a wireless connection with yet another network node; and
selecting the another as a target to reassociate the wireless connection from the yet another network node to the another network node.

25. The machine-accessible medium of claim 24 having associated instructions, which, when executed, further results in the network node exchanging a plurality of key holder identities with the another network node by:
transmitting a fast transition (FT) request to the another network node, the FT request including an FT information element (FTIE) having an identification of a key holder associated with the yet another network node; and
receiving an FT response from the another network node, the FT response including another FTIE having an identification of another key holder associated with the another network node.

26. The machine-accessible medium of claim 25 having associated instructions, which, when executed, further results in the network node exchanging a plurality of key holder identities with the another network node by:
transmitting an FT confirmation to the another network node, the FT confirmation including the another FTIE and a message integrity check (MIC); and
receiving an FT acknowledgement from the another network node, the FT acknowledgement including the another FTIE and another MIC.
